(19) United States
(12) Patent Application Publication
(10) Pub. No.: US 2006/0100920 A1
(43) Pub. Date: May 11, 2006

(54) System and method to provide supply chain integrity

(76) Inventors: Albertus Jacobus Pretorius, Pretoria (ZA); Alwyn Jakobus Hoffman, Potchefstroom (ZA)

Correspondence Address: NIXON & VANDERHYE, PC, 901 NORTH GLEBE ROAD, 11TH FLOOR, ARLINGTON, VA, 22203, US

(21) Appl. No.: 10/522,794

(22) PCT Filed: Jul. 30, 2003
(86) PCT No.: PCT/ZA03/00103

§ 371 Date: Dec. 5, 2005

(30) Foreign Application Priority Data
Jul. 30, 2002 (ZA) 2002/0875

(51) Int. Cl. G06F 11/34

(52) U.S. Cl. 705/11

(57) ABSTRACT

A method of detecting abnormalities in a supply chain wherein items of a plurality of supply chain principals are transferred in an operational field from one supply chain participant to another through various transfer transactions, comprises the steps of utilizing distributed electronic data recording equipment to collect in real time and in the operational field transaction data relating to transfer transactions involving items of all the principals. The collected transaction data is associated with an integrity index and is stored in a central trusted database. A processor is used to process the collected transaction data and taking into account the index to determine data relating to normal behavior in the chain. The processor is further used to determine whether new input data relating to transactions in the chain is indicative of behavior that deviates from the data relating to normal behavior and to provide a trigger when an abnormality in the chain is detected. The processor further identifies groups of new input transaction data that are responsible for the deviation.

### TECHNICAL FIELD

THIS invention relates to a method and system for detecting abnormalities in normal behaviour in a supply chain.

Modern supply chains (SC) are characterised by the complexity of the overall operation, resulting from, amongst other factors a plurality of supply chain participants (SCPs), each typically playing a specialist role; a network of a plurality of channels for the flow of stock keeping units (SKU); and a plurality of different SKU's that may be moving through the same network at the same time.

Best practices are normally employed by the various SCP's in order to optimise the efficiency of the operation. In some cases a supply chain service provider (SCSP) may be appointed by supply chain principals, such as brand or cargo owners, to take responsibility for the entire SC operation. In SC operations, there is the potential of a plurality of abnormalities; an abnormality is defined as a deviation from normal behaviour. These abnormalities can be broadly divided into two categories namely:
abnormalities caused by human error (e.g. including the wrong combination of SKU's in making up a shipment), or by the failure to diligently apply best practices (e.g. not completing the proof-of-delivery documentation when delivering a shipment); and
abnormalities caused by intentional misconduct of SCP's and which misconduct may take place in collusion with crime syndicates. This category of abnormality will also be referred to as irregularities.

The second category of abnormalities may include: contract manufacturers exceeding their quotas and selling excess goods through unauthorised channels without paying the required royalties or licensing fees to brand owners; wholesalers or retailers purchasing counterfeit goods from illegal suppliers, and selling these as branded goods; pilfering of goods during the delivery process at a warehouse or retail outlet, or from within a warehouse, in small enough volumes to avoid early detection; unauthorised shipments leaving warehouses and intended for blackmarket retailers, using the documentation generated for legal shipments to approve the handling of such shipments; hijacking of shipments during transportation in collusion with transportation agents or its employees; round-tripping of goods from retail to warehouses, specifically in scenarios where the retail goods have been paid for by a third party like the state.

Both types of abnormality can result in substantial financial losses for the brand or cargo owner.

One of the difficulties in addressing these problems is the fact that the impact of these problems can often only be detected indirectly, by observing parameters that could be measured directly. Furthermore, the field measurements that are normally available to detect abnormal behaviour and to identify the cause are in practice limited by boundaries caused by proprietary data. Still furthermore, the available field data is typically restricted to that set of data that can be generated and collected as part of SC best practices. However, typical examples of measurable parameters that may serve as indicators of the presence of abnormalities, without directly identifying the underlying cause, may include the following: time delays in the flow of specific goods between specific points of control in the supply chain tend to be much shorter or longer than normal; systematic discrepancies occurring between actual volumes of goods flowing through specific points of control and the expected volumes, based on volumes detected at points of control upstream in the supply chain etc.

In most cases it is however not possible to directly relate any of these indicators or measurable parameters with a specific abnormality or with the actions of a specific SCP. Since the different types of abnormality may have very similar impacts on some of the measurable parameters, it may be impossible to identify the underlying cause by considering only one such measurement, or too limited a set of measurements, at a time. The result is that the detection of an abnormality and the identification of its cause is a complex and difficult task.

One implication of the above description is the fact that reliable detection at an early stage of abnormalities in supply chains will normally require the availability of complete knowledge, not only of all information reflecting supply chain activities, but also of all business rules that determines what type of behaviour can be deemed to be normal or abnormal. In practical scenarios this is usually not possible, making the timeous and reliable detection of such abnormalities an impossible task. Therefore, known enterprise resource planning (ERP) techniques and systems are able to detect a limited number and kind of abnormalities in a supply chain. Moreover, the proprietary nature of data and hence jurisdictional limitations to access by other SCP's of these techniques and systems, may have the effect of two or more abnormalities cancelling one another, so that the known ERP systems and techniques may be wanting in some applications. Furthermore, the known systems do not take integrity of data and the recording thereof into account.

### OBJECT OF THE INVENTION

Accordingly it is an object of the present invention to provide a method and system with which the applicant believes the aforementioned problems may at least be alleviated.

### SUMMARY OF THE INVENTION

According to the invention there is provided a method of detecting abnormalities in a supply chain wherein items of a plurality of supply chain principals are transferred in an operational field from one supply chain participant to another through transfer transactions, the method comprising the steps of:
capturing in the operational field data relating to transfer transactions involving items of all the principals, utilizing distributed electronic data recording equipment;
storing the captured transaction data in a central trusted database;
processing the stored data utilizing a processor, to determine data relating to normal behaviour in the chain; and
determining by utilizing the processor whether new input data relating to transactions in the supply chain is indicative of behaviour that deviates from the data relating to normal behaviour, thereby to detect an abnormality in the supply chain.

The capturing of the data is preferably performed by an independent trusted party and independently from the known logistic supply information systems of the principals.

The captured data may be encrypted before communication thereof to the central database.

The captured data relating to each transfer transaction may comprise a data collection comprising at least one of: data relating to the item, data relating to a receiver of the item, data relating to a transferor of the item, data relating to a time of the transaction and data relating to a place of the transaction.

Each data collection may be associated with an integrity index relating to the integrity of the data collection and wherein the integrity index is preferably utilized by the processor in at least one of said processing step and said determining step.

The processor may further be configured to identify a group of new input data collections that is responsible for the indication of behaviour that deviates from normal behaviour, thereby to enable further scrutiny of the group of new input data collections.

According to another aspect of the invention there is provided a system for detecting abnormalities in a supply chain wherein items of a plurality of supply chain principals are transferred in an operational field from one supply chain participant to another through transfer transactions, the system comprising:
a central trusted database;
a processor operatively connected to the database;
a plurality of transaction data recording device operable to capture in the operational field data relating to transfer transactions involving items of all the principals;
means for communicating the captured data from the devices to the central trusted database, to be stored in the database;
the processor being configured to derive from the stored data, data relating to normal supply chain behaviour; and
the processor further being configured continually to monitor new input transaction data communicated from the devices and to detect deviations from said data relating to normal supply chain behaviour and to provide a trigger in response thereto indicating an abnormality in the supply chain.

Each device may comprise encryption means for encrypting the captured data.

The processor preferably forms part of a trainable artificial intelligence decision making system.

### BRIEF DESCRIPTION OF THE ACCOMPANYING DIAGRAMS

The invention will now further be described, by way of example only, with reference to the accompanying diagrams wherein:

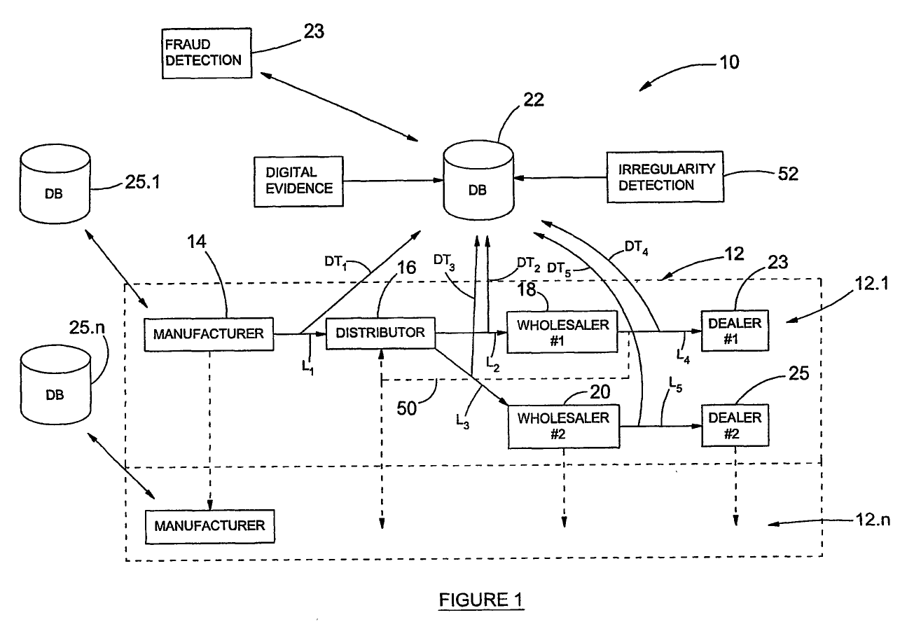

FIG. 1 is a block diagram of a supply chain and parts of the system according to the invention;

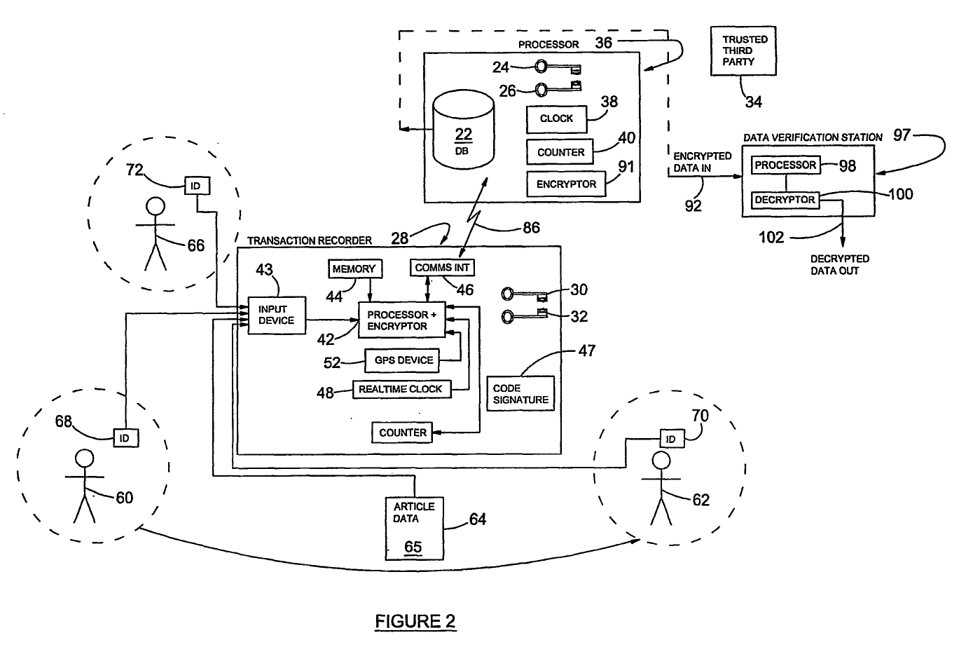

FIG. 2 is a block diagram of part of the system illustrating apparatus and a method of capturing and recording data relating to a transfer transaction in the chain;

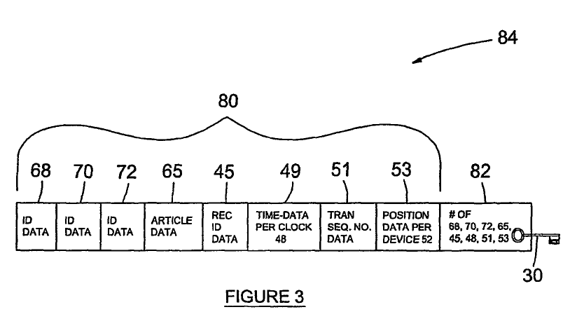

FIG. 3 is a diagrammatic representation of the captured data;

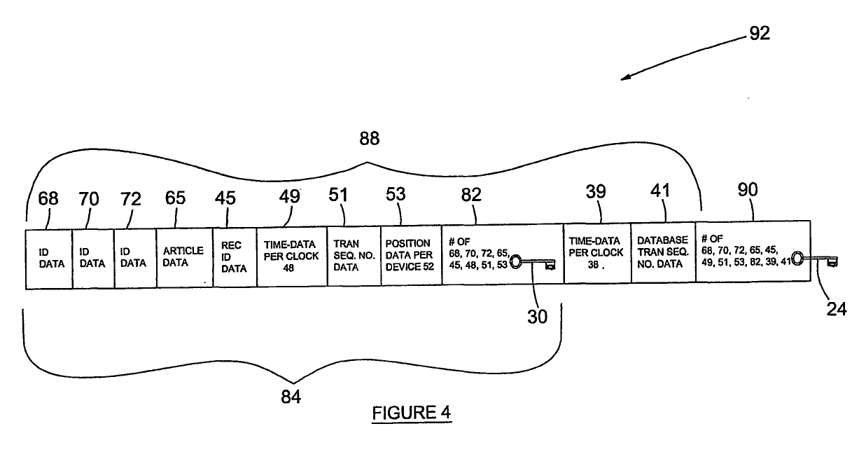

FIG. 4 is a diagrammatic representation of captured data as recorded in a central database;

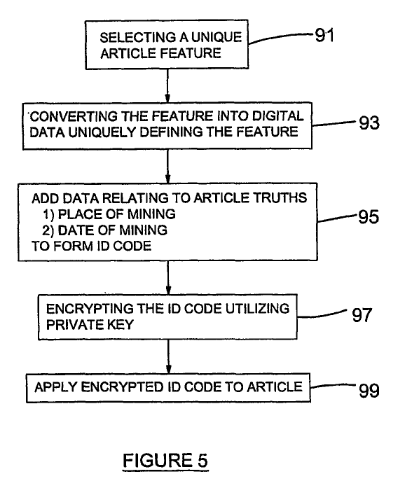

FIG. 5 is a flow diagram of a method of marking an article or stock keeping unit (SKU) to be distributed through the chain;

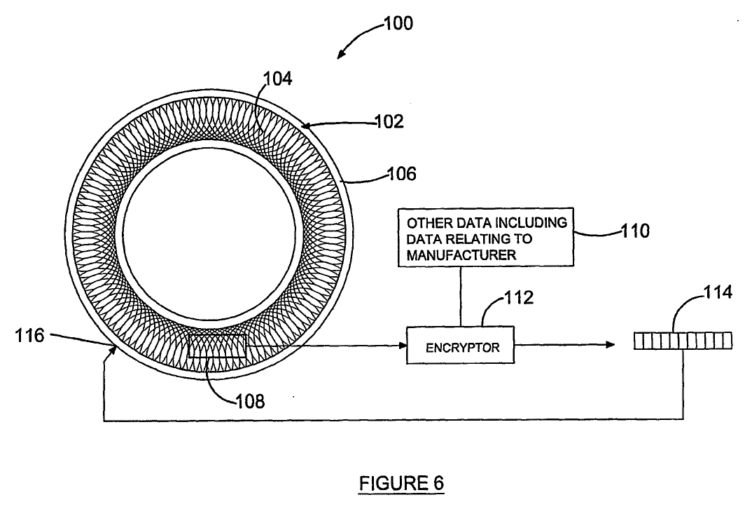

FIG. 6 is a diagrammatic representation of one example of a system and method of marking an SKU, in this case a tyre for a vehicle wheel;

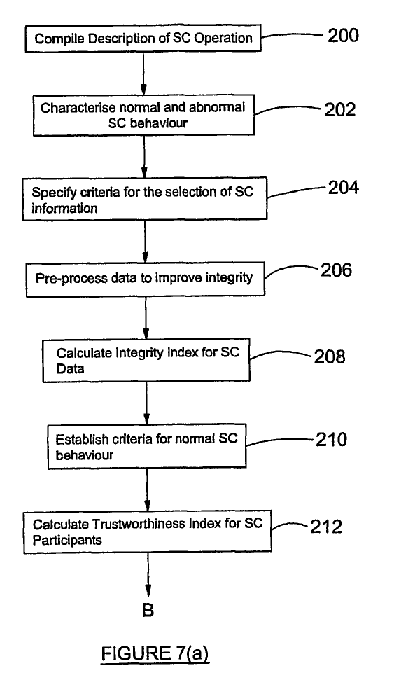

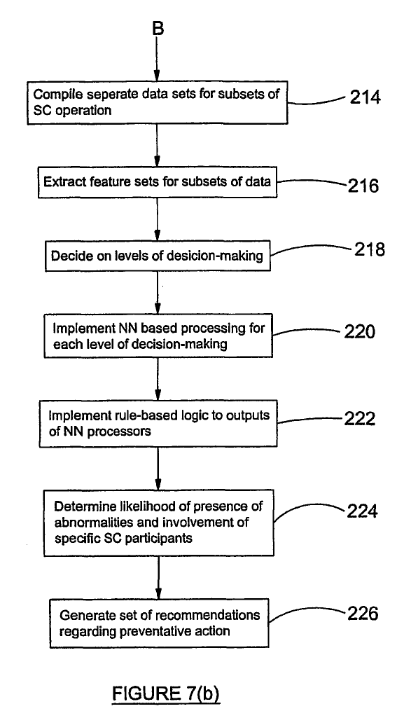

FIGS. 7(a) and (b) is a high level flow diagram of the method according to the invention of detecting an abnormality in supply chain behaviour;

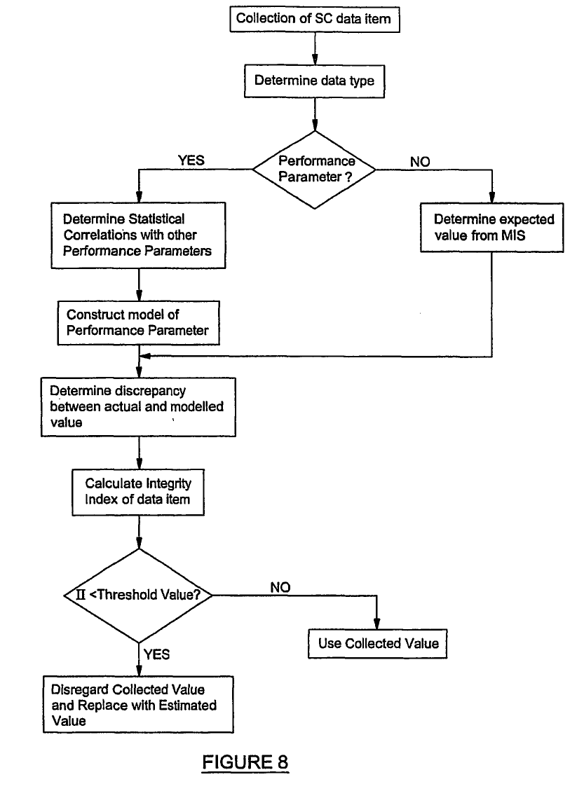

FIG. 8 is a flow diagram of a method of calculating an integrity index for data collected as part of the aforementioned method according to the invention;

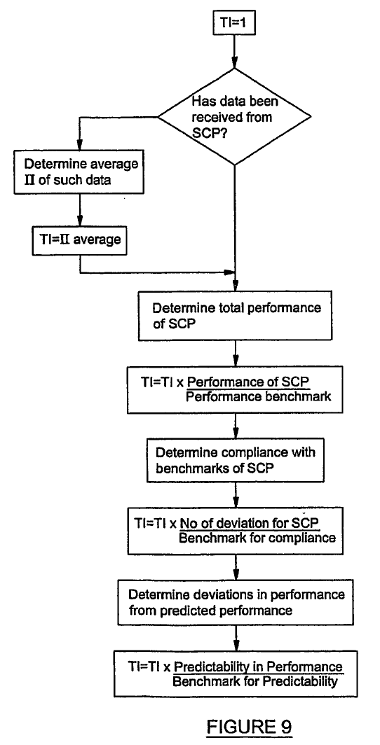

FIG. 9 is a flow diagram of a method of computing a trustworthiness index for each supply chain participant (SCP) as part of the method according to the invention;

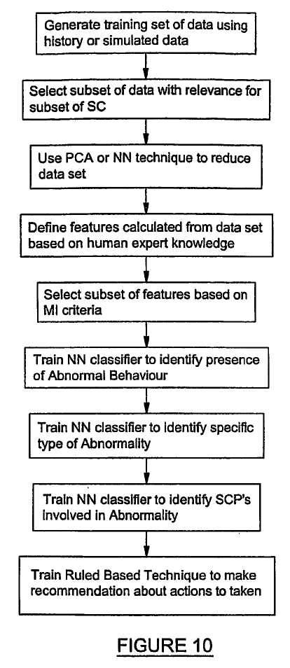

FIG. 10 is a flow diagram of a known method to train an artificial intelligence decision making system forming part of the system according to the invention;

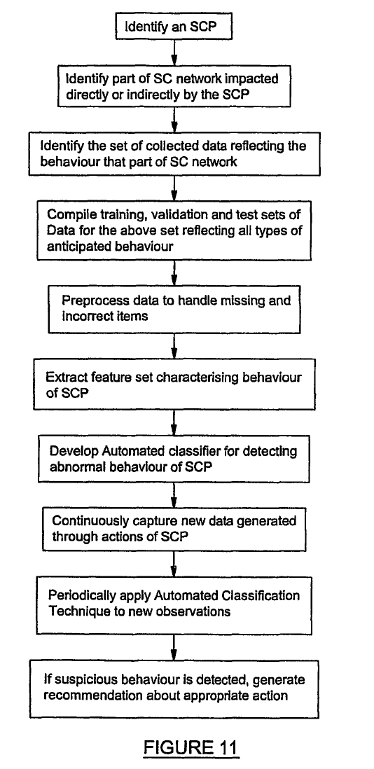

FIG. 11 is a flow diagram of a method to scrutinize the behaviour of a selected SCP; and

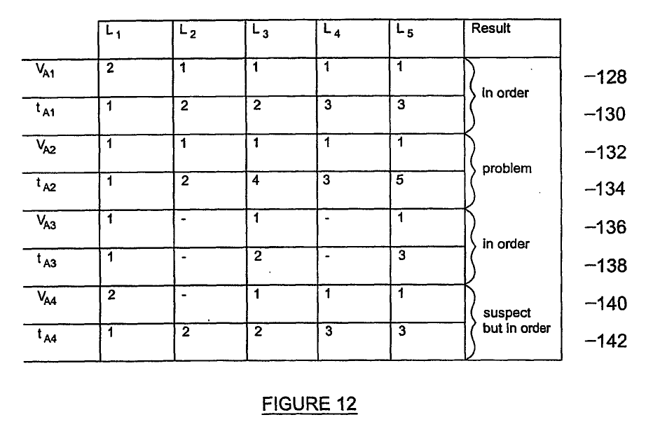

FIG. 12 is a table reflecting volumes of goods in legs of the chain in FIG. 1 and relative times of transactions in each leg of the chain.

### DESCRIPTION OF A PREFERRED EMBODIMENT OF THE INVENTION

In FIG. 1 there is shown a diagram of a supply chain 12 and part of a system 10 according to the invention for detecting abnormalities in behaviour in the supply chain (SC) 12.

The supply chain 12 is a complex one comprising in combination, the respective chains 12.1 to 12.n associated with each of a plurality of supply chain principles respectively. These respective chains may at least partially overlap and each respective chain or part of the complex chain 12 typically comprises a manufacturer 14, a distributor 16, a plurality of wholesalers of which two only are shown at 18 and 20 and a plurality of dealers of which two only are shown at 23 and 25. In the known systems each supply chain principal has access to only his own transaction data and operational rules. This proprietary data is stored in a respective proprietary database 25.1 to 25.n. This data in its operational context is confidential and very valuable to each principal. Hence, principals are not prepared to share this data with other principals or SCP's.

In the applicant's co-pending International Patent Application PCT/ZA03/00012 entitled “System and method of authenticating a transaction”, there are disclosed a method and system of capturing transaction data in the supply chain and of securing that data. The contents of the specification of application PCT/ZA03/00012 are incorporated herein by the above reference.

In this and the aforementioned specification of PCT/ZA03/00012, the term “transaction” is used to denote a transfer of an article by a transferor, such as delivery person 60 (shown in FIG. 2) of manufacturer 14 to a receiver, such as receiver person 62 of distributor 16. Transaction data comprises a collection of at least one of data relating to a unique aspect of the transferor, data relating to a unique aspect of the receiver, data unique to the article and data indicating the transaction time and place where the transaction occurred. The transaction data is captured as aforesaid and signed digitally as explained in the specification of the aforementioned application PCT/ZA03/00012 to protect the integrity of the data. The data is then stored in a central database 22 which is under control of a trusted third party (not shown). By capturing, signing and storing the data as aforesaid, it is believed that the stored data has a high integrity when compared to data gathered in accordance with conventional techniques that are applied in the known supply chains. It is believed that the high integrity data may be used as digital evidence of the transactions and as traces of a trail of digital evidence data of the transactions and hence the flow of the article in physical or real world time from one position to another position through the SC 12.

Hence, each such transaction data collection constitutes trace data of a trail of the article or stock keeping unit (SKU) moving in physical or real world space-time through the chain.

Data relating to each transaction along the chain 12 is captured, digitally secured and stored in a trusted and independent digital evidence database 22 as hereinafter described.

As shown in FIG. 2, the central digital evidence database 22 has associated therewith a private key 24 and an associated public key 26 of an asymmetric encryption key pair. The data is recorded by a plurality of electronic transaction recorders, at least some of which are portable and only one of which is shown at 28. The recorder in use serves as a real time witness of the transaction and data relating to the transaction is captured in the operational field, secured and stored to serve as non-manipulatable and non-repudiable evidence. Each transaction recorder is also associated with an own and unique public key 30 and associated private key 32 of an asymmetric encryption key pair. The public key 26 of the database and the public keys 32 of all the transaction recorders are certified in known manner in terms of a known public key infrastructure (PKI) process with an independent and trusted third party 34. The private keys are kept secret and are used by the recorders and a database processor 36 only. The transaction recorders hence constitute trusted extensions of the digital evidence database 22.

A processor 36 cooperating with the database 22 comprises a tamper proof real time clock 38 providing time data 39 and a tamper proof transaction counter 40, providing data 41 relating to a database transaction sequence number.

Each transaction recorder 28 comprises a processor 42, a data input device 43, a memory arrangement 44, a data communications interface 46, a tamper proof real time clock 48 for providing time data 49, a tamper proof transaction counter 50 for providing data 51 relating to a transaction sequence number and physical position determining means, such as a global position system (GPS) device 52, for providing position data 53. A unique ID code 45 for the recorder is permanently embedded in the memory arrangement 44.

Reference is now made to FIGS. 1 to 3 and to the first transfer or transaction in the chain, as an example, that is between manufacturer 14 and wholesaler 16. At the time of the transfer of the articles 64, the following data is entered via device 43 and captured by the portable transaction recorder 28 which may be carried and operated by an independent operator 66: identification data 68 (such as an ID number, password, biometric data etc) relating to delivery person 60; identification data 70 relating to receiver person 62; identification data 72 relating to operator 66; and data 65 relating to the articles 64. The aforementioned data is preferably captured within a predetermined time window, to ensure that all three parties and the articles are present at transfer, thereby to avoid tampering with input data.

Referring to FIGS. 2 and 3, in a next step, the processor 42 of the recorder 28 adds to the aforementioned data, the following: data 45 relating to an identity of the recorder obtained from memory arrangement 44, data 49 relating to time of the transaction obtained from clock 48, data 51 relating to a recorder transaction sequence number obtained from counter 50 and data 53 relating to a physical position of the transaction obtained from device 52, to form a transaction data collection 80 shown in FIG. 3. The processor 42 automatically increments the count data 51 of the counter 50 at the start of a new transaction.

In a further step the processor 42 computes a Hash of the collection 80 and utilizes private key 30 to encrypt the Hash and to form a digest 82, thereby digitally to sign the transaction data collection 80 in known manner. The result is a digitally signed transaction data collection 84, which is transmitted via communications channel 86 (shown in FIG. 2) to the processor 36 at database 22.

As shown in FIG. 4, at the processor 36 there is added to the digitally signed transaction data collection 84, data 39 obtained from clock 38 relating to the time of receipt of the digitally signed transaction data collection 84 and data 41 relating to a transaction sequence number for the database obtained from counter 40, to form a database transaction data collection 88.

In a next step, the processor 36 causes the database transaction data collection 88 to be signed digitally by encryptor 91 (shown in FIG. 2) at 90 as hereinbefore described, utilizing the private key 24 associated with the database. The digitally signed database transaction data collection 92 is stored in the database 22.

Similarly, corresponding data is captured, secured and stored in the database 22 when a delivery person of distributor 16 transfers the goods to a receiver person of wholesaler 18. In this case a recorder 28 which may be permanently located at the premises of wholesaler 18 is used. In this manner, transaction data involving the articles of all principals utilizing the chain 12 is captured, secured and stored. It is believed that since the data is captured by or on behalf of an independent trusted third party and not in their full operational context, but in an unrelated context aimed at preserving a trail of digital evidence relating to operation of the chain as a whole, that the aforementioned confidential and proprietary objections would be avoided.

The transaction or trace data so collected and secured yields a trial of digital evidence with high integrity and is independent of the proprietary logistical information systems of the principals.

Should it later transpire that an article purchased by a customer is not a genuine article which originated from manufacturer 14, but a gray or pirate article, the aforementioned database transaction data relating to each of the transactions may be retrieved from database 22. The data 92 is processed at data verification station 97 comprising a processor 98 and a decryptor 100 by decrypting the data utilizing the public key 26 associated with the database and the public key 32 associated with the relevant recorder. The decrypted data 102 is then analyzed to investigate the parties and articles involved in each transaction. The database 22 and verification station 97 may be operated and controlled by a common trusted party, or alternatively by different trusted parties.

The sequence numbers used at the recorder 28 and at the database 22 ensure that transaction data collections and database transaction data collections are not deleted or lost. Furthermore, the digital signatures ensure non-repudiation and may facilitate proof of originality and integrity.

The data 65 relating to the article or SKU may be digital data relating to a unique feature of the article or a class of articles to which the articles belong. A system for and method of capturing the data is disclosed in the applicant's co-pending International Patent Application WO/031021541 entitled “System and method of authenticating an article”, the contents of the specification of which are incorporated herein by this reference. This method is summarized with reference to FIGS. 5 and 6 hereof.

At 91, the unique feature of the article is identified and the feature is digitized at 93 to yield digital data. Other truth data is added at 95 and at 97 to form a plain text ID code, which is thereafter encrypted utilizing encryption means and a private key of an asymmetric encryption key pair. The encrypted ID code is applied to the article, for example in the form of a bar code on a label accompanying the article, as illustrated at 99 in FIG. 5.

As one example, SKU's in the form of tyres 100 shown in FIG. 6 for vehicles may be authenticated as hereinbefore described. It is known that a tyre 100 comprises a casing 102, which is normally handmade of Kevlar fiber 104 for reinforcing a rubber body 106 of the tyre. The Kevlar casing has a random pattern with a uniqueness of in the order of 1:100000. It is believed that this is a currently economically viable uniqueness for this method. Digital data relating to the Kevlar pattern within a frame 108 on the tyre is obtained with a suitable scanner. Other data 110 relating to the tyre including data relating to the manufacturer and the pattern data are encrypted at encryptor 112, to provide an encrypted code 114. The encrypted code 114 is applied to the tyre at 116 and/or is provided on a separate certificate. To determine the authenticity of a tyre, the pattern in the same frame 108 must be determined. Pattern data so determined is then compared with the pattern data extracted from the encrypted code in a decryption process utilizing the public key of the manufacturer. If there is a match, the tyre is what it is claimed to be.

Referring now again to the method according to present invention for detecting abnormalities in behaviour in the supply chain 12. In a simple example of movement of SKU's through chain 12 shown in FIG. 1 and FIG. 12, the resulting pattern of volume of articles through each leg L_{1 to L}₅ of the chain and the pattern of time instants of the transactions in each of the legs are continually monitored as hereinbefore described. The symbol V_{A1} in FIG. 12 indicates the volume of SKU's of a first kind and the numerals in row 128 indicate the respective volumes in each of the legs L₁ to L₅. The symbol t_{A1} indicates the time instant of transactions involving those SKU's and the numerals in row 130 indicate the relative time instances of the transactions involving the SKU's of the first kind in each of the legs L₁ to L₅. The symbols V_{A2}, t_{A2}; V_{A3}, t_{A3}; and V_{A4}, t_{A4} have corresponding meanings for SKU's of a second to fourth kind.

By analyzing the patterns in rows 128 and 130 it is clear that the flow through the chain of the articles of the first kind is as expected and hence in order. By analyzing the patterns in rows 136 and 138 it is also clear that the flow through the chain of the article of the third kind is as expected and hence in order.

By analyzing the volume pattern in row 140, a suspicion is raised by the lack of data relating to the volume in leg L₂. However, by analyzing the volume pattern in row 140 and the time pattern in row 142 compared to those in rows 130 and 138, it appears that the abnormality in row 140 may perhaps be a data collection problem and not an irregularity in the chain. The problem may have been caused by a failure to collect at least some of the transaction data in leg L₂.

In the event of round tripping of articles of the second kind, for example via broken line 50 shown in FIG. 1, it is believed that in a closed system where each party in the chain has exclusive jurisdiction over his own ERP systems and data, that through collusion, the ERP system of any one party may not detect the round tripping.

However, in the method according to the invention, which is preferably performed by an independent party based on transaction or trace data recorded in the operational field as hereinbefore described, the unexpected time delay where column L₃ and row 134 intersect, would raise a suspicion. By analyzing row 132, it is clear that a larger volume flow is required in leg 1 to result in the flows in the other legs.

By comparing the time of transaction rows 130, 134, 138 and 142, it becomes apparent that a potential fraud has occurred in one or more of legs L₂, L₃ and L₄.

The method and system according to the invention will trigger an alarm which will then be investigated by experts or expert systems such as fraud detection agent 23 shown in FIG. 1. The alarm comprises an indication of the most likely cause of the deviation from normal behaviour in the form of a group of transaction data that are involved and/or of the SCP's that are implicated in the process.

The system 10 shown in FIG. 1 according to the invention comprises the aforementioned central and trusted database 22 with digital evidence. A computerized irregularity detection system 52 comprising a self-learning pattern recognition system is utilized to establish, update, monitor and analyze the patterns.

Hence, in order to increase the ability of SC principals such as brand owners, etc to detect abnormal SC behaviour, the following general measures may be taken, in addition to the normal measures for managing SC operations: additional identification information may be added to the markings on goods and on trade documentation to make falsification of such markings more difficult (as illustrated in FIGS. 5 and 6); additional elements may be added to normal SC best practices, e.g. by forcing human operators to collect specific data, such as biometric identification data, when handling or transferring goods; the behaviour over time of each SCP and of each human operator may be scrutinized and compared with the behaviour of other similar players in order to detect suspicious behaviour; computerized trend analysis and pattern recognition techniques may be applied to differentiate normal behaviour from abnormal behaviour, and to identify the cause. This implies the ability to discriminate between random and systematic deviations, as well as the ability to associate a specific set of systematic deviations with a specific cause.

A preferred form of the method may alleviate some of the problems that may be encountered in successfully applying the aforementioned general approach. The preferred form involves a structured approach and a carefully designed methodology that includes the following steps as illustrated in FIGS. 7(a) and 7(b).

Compiling at 200 a complete definition of the entire SC operation, including: a description of the entire SC network, including the identification of all supply chain participants (SCPs), the description of the role of each SCP in terms of expected normal behaviour, the identification of all the SKU's moving through the network, the manner in which each SKU should be marked, the types of transfer of goods that may take place between each combination of SCPs, and the associated trade documentation that should accompany each such transfer; a description of all the channels for the flow of goods that are normally allowed, based on the above description of the network, its participants and the allowed transfers that may take place among them; a description of all data that should be collected as part of applying best practices in transfers of goods and observing the operation, and that can be used as physical measurements of SC behaviour; and a description of the set of best practices that should be applied by each type of SCP.

At 202, normal and abnormal SC behaviour are characterized. The statistical behaviour of the measurable parameters that are collected as part of best practices are characterised under a representative set of conditions. This may be done by determining a set of statistical moments for each parameter, the first moment being the average value of the parameter, the second moment being the variance of the parameter, etc. A representative set of conditions can be defined as conditions that, when applied to the SC, will reflect all the inherent types of behaviour that are characteristic of that SC. For this purpose it may be necessary to utilise a computerised model of the SC that can be used to simulate SC behaviour under different conditions.

A standard value for the identified set of performance measures applicable to each type of SCP is calculated. These standard levels of performance will serve as benchmarks against which to compare the actual performance of SCPs and of human operators during SC operation.

Abnormal SC behaviour is characterized by determining the impact of the presence of any individual abnormality, or sets of abnormalities that are present at the same time, on the statistical behaviour of the above measurable parameters. For this purpose it may once again be necessary to utilise a computerised model of the SC that has the ability to model the impact of such abnormalities.

The next step is shown at 204 and involves specifying criteria for the information that should be collected as hereinbefore described at each transaction or point of monitoring or control in the SC, as part of the application of best practices. This information may, as hereinbefore described, include: the identification markings of the goods, the origin and destination of the goods, the human operators involved in the transfer of goods, the time and place of the transfer, and a transaction identifier or number for each transfer; the completeness of the data collected and submitted by each SCP and human operator; the method of recording that was used (e.g. paper based or electronic mechanisms); the timeliness of submission of the data by the SCP or human operator; deviations between field data submitted and corresponding data already available on a Management Information System (MIS) of the SCP that receives the goods, relating to the same goods and the same transactions.

The next step shown at 206 involves pre-processing of data that is collected and submitted, in order to address issues such as missing or erroneous data. One way to deal with these issues, would be as follows: in the absence of submitted values for specific data fields, the absent value could be replaced by deriving the most likely value from other available data. For example, if the quantity of goods received has not been captured, this could be replaced by the quantity appearing on the shipment documentation. The absence of such data items is however registered on the system. Similarly, data items that are obviously incorrect are replaced by the most likely value and the presence of the error registered. For example, if the date appearing on a document is a future rather than a historic date, it could be replaced by the expected date for such a transaction.

The next step shown at 208 is calculating and integrity value (hereinafter referred as the Integrity Index or “II”) for each data item that is collected. The II is calculated both for data collected in the field and for data recorded through available back-office systems. The II of a data item will determine the extent to which the reliability and accuracy of that data is accepted by subsequent decision making processes. A default value of the II may be selected as one (1) for any data item.

For data that can be defined as behavioural parameters (indicative of some level of performance, e.g. time period to complete an operation or percentage of goods lost during an operation) the II may be calculated based on the approach which is illustrated in FIG. 8.

The statistical correlations between the various behavioural parameters are determined under normal operational conditions (i.e. in the absence of any abnormalities). For each behavioural parameter a model is constructed that calculates an estimated value of this parameter by using the values of other behavioural parameters. The set of other parameters used for this purpose is selected based on the statistical correlations of such parameters with the parameter being modelled. For each behavioural parameter the discrepancy between its actual value and its estimated value as determined above is calculated. A large discrepancy would result in a lower II value for the respective parameter.

For other types of data (e.g. identification data of goods or people) this approach to calculate the II may not be suitable. The following alternative approach may rather be implemented. For each collected data item, the expected value is obtained from the MIS, based on other data that may have been previously generated. For example, in the case of goods delivered, the expected values of the identifiers of the goods delivered are the identifiers appearing on the shipment documentation generated when the goods were dispatched. If there is a discrepancy between the actual value of such a data item and the expected value, the value of the II is decreased. If no other data is available on the MIS from which to determine an expected value, the II is allocated a value of one.

If the II of a data item is below a predefined threshold value, the captured value is discarded and replaced by the estimated value as determined above.

As shown at 210 in FIG. 7(a), the next step is to establish a set of criteria for the expected normal behaviour of each SCP. These criteria may include: compliance with standard performance measures for each aspect of behaviour, including timeliness, loss levels and quality standards; diligent application of the agreed set of best practices for the respective SCP, specifically relating to best practices in the transfer of goods and the collection and submission of related data; maintaining stable and predictable behaviour in terms of its participation in the SC network, specifically relating to the volumes of goods ordered from and supplied to other participants, compared to past behaviour.

Unpredictable behaviour is defined as behaviour for which the corresponding performance parameter deviates from the expected performance by more than a predefined percentage. Expected performance is based on historic performance over a predefined time period.

At 212 in FIG. 7(a) there is calculated a trustworthiness index or TI for each SCP. One way to calculate the TI is as follows and is illustrated schematically in FIG. 9, which is self explanatory: initially the TI is allocated a value of one (1). If data relating to SC operations has previously been received from this SCP, the TI is multiplied by the mean value of the II of all such data previously received. The level of compliance of the SCP with standard performance measures is calculated as a ratio between the performance of this SCP and the standard benchmark performance level. The TI is then multiplied by this figure. The level of compliance with best practices of the SCP is calculated as the ratio between the number of reported deviations associated with this SCP, and the standard benchmark for such deviations. The TI is then divided by this figure.

The level of unpredictability in behaviour of the SCP is calculated as the ratio between the average deviation in actual performance from predicted performance, and the standard benchmark for such deviations. The TI is divided by this figure.

The TI of a SCP may be used for the following purposes.

It impacts the value of the II of all future data received from that SCP.

The simplest way to calculate this impact is by multiplying the existing 11 of a data item by the TI of the SCP from which the data was received.

When the TI of a SCP exceeds a predefined threshold, this triggers a condition that results in the closer scrutiny of that SCP. Such closer scrutiny may include the periodic analysis of recent behaviour of the respective SCP, in order to identify potential involvement in abnormal behaviour.

As shown at 214 in FIG. 7(b) a next step is subdividing the entire available data set (including the II and TI values calculated as hereinbefore described) into subsets of data, each subset reflecting the total behaviour of an identifiable subset of the total SC network. This may for example be that part of the SC operation impacted by a specific SCP, the operations taking place in a specific geographical region, or all of those entities forming one channel for the flow of goods.

As shown at 216, from each such subset of data, a set of features are extracted. These features are defined based on the following criteria:
To reflect and represent as completely as possible those aspects of behaviour that are indicative of abnormal behaviour in general, and of specific types of abnormal behaviour associated with specific underlying causes in particular.
To retain in the feature set a level of redundancy of information that is deemed as necessary and sufficient in order to sustain the robustness of the feature set in cases where the integrity of any one feature may be suspect.

The extraction of the features from the original set of variables will typically lead to substantial reduction of the size of the data set. This is normally an essential step, since the original data set is usually too large to be used directly for decision making by either a human operator or an automated technique.

The sets of features described above may be extracted using one or more of the following techniques:
Using human expert knowledge to define aggregate parameters, derived from the original data set, that will accurately represent specific types of abnormal behaviour. A simple example may be the average time that it takes for a certain SCP to complete some standard operation. A more advanced example may be the difference over a sufficiently long period of time between the total manufacturing quotas of legal manufacturers and the total number of units sold over the same period of time, as determined through market surveys.
Using mathematical techniques, based on the relations between different variables, to create a new and reduced set of variables that will represent an acceptable percentage of the total statistical fluctuations in the original data set. Two such techniques are: principle component analysis (PCA) that is based on the statistical correlations between the original set of variables, and that creates the new set of variables as the Eigen vectors of the cross-correlation matrix of the original variables; and the so-called Karhunen-Loeve neural network technique, that achieves a similar result by modelling the original set of variables in terms of a reduced new set of variables.

Mathematical techniques may be used to select from the original data set, or from the feature set, those variables that will contribute optimally, according to some criterion, to the ability of the feature set to indicate the presence of a specific abnormality. One such technique, that is based on the statistical correlation of the potential new feature with the presence of the abnormality, as well as its statistical correlations with already selected features, is the so-called Mutual Information Criterion.

As shown at 218, the next step involves dividing the decision-making process regarding the presence of a specific abnormality into one or more levels. The first level of decision-making may indicate if the current situation is considered to be normal or abnormal. A second level of decision making may indicate if an abnormality that is present falls into a specific category, e.g. legal or illegal behaviour. A further level of decision making may identify the most likely cause of the observed abnormality.

As shown at 220, for each level of decision making a neural network (NN) architecture may be used to accept the selected set of features, to process this data and to generate one or more outputs. The neural network architecture may include several different levels of data processing. It may furthermore possess fuzzy logic capabilities to model the inherent statistical nature of the input and intermediate variables.

As shown at 222 in FIG. 7(b), in between each level of neural network based data processing, a form of rule-based decision making may be used, either to decide what type of further data processing is required, or to come to a conclusive decision regarding the overall problem. The values of the output variables of a NN are evaluated based on the application of predefined threshold values that may be exceeded by the output values. From these comparisons it will be possible to come to a conclusive decision that is relevant to the respective level of decision making.

The set of techniques as described above are periodically applied to each set of data, representing a particular aspect of the overall SC behaviour. In this way the behaviour of each identifiable subset of the total SC network, as well as the behaviour of each individual SCP, may be evaluated on a regular basis to detect abnormal behaviour. Also in this way, trends are generated over time of the behaviour of different SCPs as it may appear in different parts of the SC. Any decision regarding the presence of an abnormality and regarding the involvement of any SCP in such an abnormality is taken by not only utilising the current outcomes of such evaluations, but also the trends in behaviour over a specified period of time.

As shown at 224 in FIG. 7(b), the final results produced by the techniques as described above include:
an indication of the likelihood that the SC operation is currently characterised by abnormal behaviour; this likelihood may be expressed in the form of a probability;
set of likelihoods for the presence of each type of abnormality that may possibly occur in this SC operation, which may also be expressed as probabilities;
the time instance when the presence of such an abnormality was detected;
the physical location or locations where the abnormal behaviour is introduced into the SC network;
the likely SCPs that are involved in each type of abnormality that has been detected;
the extent to which any abnormality is occurring (e.g. percentage of goods lost through a particular irregularity) as well as the associated financial losses to the brand or cargo owner is calculated; and
as shown at 226 in FIG. 7(b), a recommendation to the operator of this system regarding possible action, based on the probability of the presence of an abnormality, the probability of the involvement of specific entities, and the size of losses that are incurred; this recommendation is accompanied by all of the supporting evidence that can be related to the chain of events culminating in the detection of the abnormality and the implication of the respective entities involved in such abnormality.

FIG. 10 is a self-explanatory flow diagram of a method to train an artificial intelligence decision making system forming part of the system according to the invention. FIG. 11 is a self-explanatory flow diagram of a method to scrutinize the behaviour of a selected SCP.

1. A method of detecting abnormalities in a supply chain wherein items of a plurality of supply chain principals are transferred in an operational field from one supply chain participant to another through transfer transactions, the method comprising the steps of:
capturing in the operational field data relating to transfer transactions involving items of all the principals, utilizing distributed electronic data recording equipment;
storing the captured transaction data in a central trusted database;
processing the stored data utilizing a processor, to determine data relating to normal behaviour in the chain; and
determining by utilizing the processor whether new input data relating to transactions in the supply chain is indicative of behaviour that deviates from the data relating to normal behaviour, thereby to detect an abnormality in the supply chain.

2. A method as claimed in claim 1, wherein the capturing of the data is performed by an independent trusted party.

3. A method as claimed in claim 1, wherein the captured data is encrypted before communication thereof to the central database.

4. A method as claimed in claim 1, wherein the captured data relating to each transfer transaction comprises a data collection comprising at least one of: data relating to the item, data relating to a receiver of the item, data relating to a transferor of the item, data relating to a time of the transaction and data relating to a place of the transaction.

5. A method as claimed in claim 4, wherein each data collection is
associated with an integrity index relating to the integrity of the data collection and wherein the integrity index is utilized by the processor in at least one of said processing step and said determining step.

6. A method as claimed in claim 1, wherein the processor is further configured to identify a group of new input data collections that is responsible for the indication of behaviour that deviates from normal behaviour, thereby to enable further scrutiny of the group of new input data collections.

7. A system for detecting abnormalities in a supply chain wherein items of a plurality of supply chain principals are transferred in an operational field from one supply chain participant to another through transfer transactions, the system comprising:
a central trusted database;
a processor operatively connected to the database;
a plurality of transaction data recording device operable to capture in the operational field data relating to transfer transactions involving items of all the principals;
means for communicating the captured data from the devices to the central trusted database, to be stored in the database;
the processor being configured to derive from the stored data, data relating to normal supply chain behaviour; and the processor further being configured continually to monitor new input transaction data communicated from the devices and to detect deviations from said data relating to normal supply chain behaviour and to provide a trigger in response thereto indicating an abnormality in the supply chain.

8. A system as claimed in claim 7, wherein each device comprises encryption means for encrypting the captured data.

9. A system as claimed in claim 7, wherein the processor forms part of a trainable artificial intelligence decision making system.
